(19) United States
(12) Patent Application Publication
(10) Pub. No.: US 2014/0266173 A1
(43) Pub. Date: Sep. 18, 2014

(54) Inspection Device and Method for Inspecting Physical Properties of a Steel Ball by Using Eddy Current

(71) Applicants: Ya-Chen Hsu, Taichung City (TW); Fang-Chih Tien, Taichung City (TW); Yi-Ji Chen, Changhua County (TW)

(72) Inventors: Ya-Chen Hsu, Taichung City (TW); Fang-Chih Tien, Taichung City (TW); Yi-Ji Chen, Changhua County (TW)

(21) Appl. No.: 13/829,429

(22) Filed: Mar. 14, 2013

(51) Int. Cl. G01N 27/90

(52) U.S. Cl. CPC G01N 27/904
USPC 324/232

(57) ABSTRACT

An inspection device and method are capable of inspecting physical properties of a steel ball quickly and precisely by using eddy current. The inspection device includes an inspection passage and an inspector has a plurality of probes located in the inspection passage. Each of the probes can produce a specific magnetic field and detect eddy current change produced by the steel ball when moving through the magnetic field, whereby to produce a signal. Then, the signal will be analyzed by the inspector and converted into physical property data of the steel ball.

### BACKGROUND OF THE INVENTION

1. Field of the Invention

The present invention relates to a steel ball inspection device and method, and more particularly to an inspection device and method for inspecting physical properties of a steel ball by using eddy current.

2. Description of the Prior Art

In order to reduce the friction of the motion transmission machine, the current method is to use steel ball as medium to improve transmission efficiency. Therefore, the quality of the steel ball becomes very important, and the current defect inspection items include: surface profile, roundness, surface roughness and stain, and etc.

The conventional defect inspection method is to check the surface of the steel ball which is placed under the light with naked eyes or with low power magnifiers. However, people's eyes will become tired after staring at the ball for a long time. Besides, human' vision is only sensitive to the width of the defect, and the defects, such as small and deep cracks, and folds, are difficult to find and very likely to be neglected. On top of that, the convention inspection method is only able to detect the outer surface of the ball based on the intensity of light reflection or classify the balls on size, but is unable to inspect the interior defect of the steel ball.

The present invention has arisen to mitigate and/or obviate the afore-described disadvantages.

### SUMMARY OF THE INVENTION

The primary objective of the present invention is to provide an inspection device and method capable of inspecting physical properties of a steel ball quickly and precisely by using eddy current.

To achieve the above objective, an inspection device for inspecting physical properties of a steel ball by using eddy current in accordance with the present invention, comprises: a base, an inspection passage, a feeding port, a discharging port and an inspector. The inspection passage is defined by and between a push rod and a stationary rod which are fixed on the base. The feeding port is located at one end of the inspection passage and fixed to the base to feed the steel ball into the inspection passage. The discharging port is located at another end of the inspection passage and mounted on the base. The inspector is mounted on the base and includes a plurality of probes with one end located in the inspection passage. Each of the probes produces a specific magnetic field and detects eddy current change of the steel ball produced when the steel ball passes through the magnetic field, whereby to produce a signal which is to be analyzed by the inspector and converted into physical property data of the steel ball.

An inspection method for inspecting physical properties of a steel ball by using eddy current in accordance with the present invention comprises the following steps:

providing a steel ball inspection device which includes an inspection passage and an inspector, the inspection passage including a feeding port and a discharging port, the inspector including at least one probe which has one end disposed in the inspection passage, the probe producing a specific magnetic field;

feeding the steel ball into the inspection passage via the feeding port;

making the steel ball move in the inspection passage, using the probe to detect eddy current change of the steel ball produced when the steel ball passes through the magnetic field, whereby to produce a signal;

using the inspector to analyze the signal and convert the signal into physical property data of the steel ball; and

moving the steel ball out of the inspection passage via the discharging port.

### BRIEF DESCRIPTION OF THE DRAWINGS

FIG. 1 shows an inspection device for inspecting physical properties of a steel ball by using eddy current in accordance with a first preferred embodiment of the present invention;

FIG. 2 is an exploded view of the inspection device for inspecting physical properties of a steel ball by using eddy current in accordance with the first preferred embodiment of the present invention;

FIG. 3 is a cross sectional view of the inspection device for inspecting physical properties of a steel ball by using eddy current in accordance with the first preferred embodiment of the present invention;

FIG. 4 is another cross sectional view of the inspection device for inspecting physical properties of a steel ball by using eddy current in accordance with the first preferred embodiment of the present invention;

FIG. 5 is a flow chart showing the inspection method for inspecting physical properties of a steel ball by using eddy current in accordance with the present invention; and

FIG. 6 shows another inspection device for inspecting physical properties of a steel ball by using eddy current in accordance with a second preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

Referring to FIGS. 1-4, an inspection device for inspecting physical properties of a steel ball by using eddy current in accordance with a first preferred embodiment of the present invention comprises: a base 20, an inspection passage 30, a feeding port 21, a discharging port 22 and an inspector 40. In this embodiment, there are two inspection passages 30, two feeding ports 21, and two discharging ports 22 disposed on the base 20.

The base 20 is a box like structure for mounting of parts of the inspection device.

The inspection passage 30 is provided for carrying the steel ball 70 and allows the steel ball 70 to pass therethrough. A plurality of steel balls 70 can be simultaneously loaded in the inspection passage 30. The inspection passage 30 is defined by and between a push rod 31 and a stationary rod 32 which are arranged in parallel to each other and each have two ends fixed to two lateral sides of the base 20. The steel ball 70 is placed on or between the push rod 31 and the stationary rod 32. With the support of the push rod 31 and the stationary rod 32, the steel ball 70 can be stably positioned in the inspection passage 30. The push rod 31 is a screw, and the steel ball 70 is located in the pitch distance 311 of the push rod 31 and leaned against the stationary rod 32. Rotating the push rod 31 can make the steel ball 70 move along the inspection passage 30.

The feeding port 21 is a pipe structure whose inner diameter d is sized to allow for passage of one steel ball 70 at a time. The feeding port 21 is located at one end of the inspection passage 30 and fixed to the base 20. When the steel ball 70 is fed into the feeding port 21, it will automatically enter the inspection passage 30 because of gravity, and with the restriction of the inner diameter d of the feeding port 21, steel balls 70 will be fed in sequential order into the inspection passage 30.

The discharging port 22 is located at another end of the inspection passage 30 and mounted on the base 20. In this embodiment, the discharging port 22 takes the form of a concave portion 321 which is formed at one end of the stationary rod 32, so that the steel ball 70 will move out of the inspection passage 30 without being stopped by the stationary rod 32, when moving to the end of the inspection passage 30.

The inspector 40 is mounted on the base 20 and includes a plurality of probes 41 and an analyzer 42 connected to the probe 41. Each of the probes 41 has one end located in the inspection passage 30. Each of the probes 41 produces a specific magnetic field and detects the eddy current change of the steel ball 70 produced when the steel balls 70 pass through the magnetic field, so as to produce a signal which is to be analyzed by the analyzer 42 and converted into physical property data of the steel ball 70.

The probes 41 can be dual coil differential structure. When the probes 41 are close to the surface of the steel ball 70, and if there are defects, such as cracks, on the outer surface of the steel ball 70, the impedance of the probes 41 will change, and so will the differential output, and thus a signal will be produced.

The abovementioned is the inspection device for inspecting physical properties of a steel ball by using eddy current in accordance with a preferred embodiment of the present invention, and for the inspection method, please refer to FIGS. 1-4 again. The inspection method for inspecting physical properties of a steel ball by using eddy current in accordance with the present invention comprises the following steps:

Step 601 of producing a magnetic field: providing a steel ball inspection device which includes an inspection passage 30 and an inspector 40, the inspection passage 30 is defined by a push rod 31 and a stationary rod 32 and includes a feeding port 21 and a discharging port 22. The inspector 40 includes at least one probe 41 which has one end disposed in the inspection passage 30. The push rod 31 is a screw and the steel ball 70 is located in the pitch distance 311 of the push rod 31. Rotating the push rod 31 can make the steel ball 70 move along the inspection passage 30. The probe 41 produces a magnetic field.

Step 602 of feeding steel ball: feeding the steel ball 70 into the inspection passage 30 via the feeding port 21.

Step 603 of detecting eddy current change: making the steel ball 70 move while rotating at a uniform speed in the inspection passage 30, the probe 41 detects the eddy current change of the steel ball 70 produced when the steel ball 70 passes through the magnetic field, so as to produce a signal.

Analyzing step 604: using the inspector 40 to analyze the signal and convert the signal into physical property data of the steel ball 70.

Discharging step 605: moving the steel ball 70 out of the inspection passage 30 via the discharging port 22.

Referring then to FIGS. 3 and 4 again, after being fed into the feeding port 21, the steel ball 70 will be positioned in the inspection passage 30 defined by the push rod 31 and the stationary rod 32. The push rod 31 is a screw, and the steel ball 70 is located in the pitch distance 311 of the push rod 31 and leaned against the stationary rod 32. By such arrangements, the inspection passage 30 is applicable to different sized steel balls 70 as long as the steel balls 70 are larger than the distance between the push rod 31 and the stationary rod 32. In addition, in each of the pitch distance 311 of the push rod 31 can be disposed a steel ball 70, therefore, a plurality of steel balls 70 can be placed and inspected simultaneously in the inspection passage 30.

Rotating the push rod 31 can make the steel ball 70 move along the inspection passage 30. Furthermore, there is friction between the steel ball 70 and the stationary rod 32, which makes the steel ball 70 rotate during movement, so that the probes 41 can inspect different areas of the steel ball 70.

Each of the probes 41 produces a specific magnetic field and detects the eddy current change of the steel ball 70 produced when the steel balls 70 pass through the magnetic field. The magnetic permeability, hardness, surface defects, and residual stress of the steel ball 70 will have influence on the magnitude and direction of the eddy current, hence, the probes 41 can produce a signal which is to be analyzed by the analyzer 42 and converted into physical property data of the steel ball 70.

Referring then to FIG. 6, an inspection device for inspecting physical properties of a steel ball by using eddy current in accordance with a second preferred embodiment of the present invention comprises: a base 20, an inspection passage (not shown), a feeding port 21, a discharging port (not shown) and an inspector (not shown). As shown in FIG. 1, on the base 20 can be provided a plurality of inspection passages, a feeding port 21 and a discharging port, a plurality of steel balls 70 can be placed and inspected simultaneously in the inspection passage 30.

With the specific magnetic field produced by the probes, and analysis of the eddy current change of the steel ball 70 produced when the steel balls 70 pass through the magnetic field, the present invention is capable of detecting the diameter, material and hardness of the steel ball 70. For example, if the material of the steel ball 70 is stainless steel, no impedance will be detected, if the material is carbon steel or chrome steel, positive impedance will be detected with large linear interval, and if the material is chrome steel, positive impedance will be detected.

While we have shown and described various embodiments in accordance with the present invention, it is clear to those skilled in the art that further embodiments may be made without departing from the scope of the present invention.

What is claimed is:

1. An inspection device for inspecting physical properties of a steel ball by using eddy current, comprising:
a base;
an inspection passage defined by and between a push rod and a stationary rod which are fixed on the base;
a feeding port located at one end of the inspection passage and fixed to the base for feeding the steel ball into the inspection passage;
a discharging port located at another end of the inspection passage and mounted on the base; and
an inspector mounted on the base and including a plurality of probes with one end located in the inspection passage, each of the probes producing a specific magnetic field and detecting eddy current change of the steel ball produced when the steel ball passes through the magnetic field, whereby to produce a signal which is to be analyzed by the inspector and converted into physical property data of the steel ball.

2. The inspection device for inspecting physical properties of a steel ball by using eddy current as claimed in claim 1, wherein the push rod is a screw, the steel ball is located in a pitch distance of the push rod and leaned against the stationary rod, and rotating the push rod makes the steel ball move along the inspection passage.

3. The inspection device for inspecting physical properties of a steel ball by using eddy current as claimed in claim 1, wherein the inspector further includes an analyzer which is connected to the probe and used to analyze and convert the signal produced by the probes into physical property data of the steel ball.

4. An inspection method for inspecting physical properties of a steel ball by using eddy current, comprising the following steps:
providing a steel ball inspection device which includes an inspection passage and an inspector, the inspection passage including a feeding port and a discharging port, the inspector including at least one probe which has one end disposed in the inspection passage, the probe producing a specific magnetic field;
feeding the steel ball into the inspection passage via the feeding port;
making the steel ball move in the inspection passage, using the probe to detect eddy current change of the steel ball produced when the steel ball passes through the magnetic field, whereby to produce a signal;
using the inspector to analyze the signal and convert the signal into physical property data of the steel ball; and
moving the steel ball out of the inspection passage via the discharging port.

5. The inspection method for inspecting physical properties of a steel ball by using eddy current as claimed in claim 4, wherein the steel ball rotates at a uniform speed when moving in the inspection passage.

6. The inspection method for inspecting physical properties of a steel ball by using eddy current as claimed in claim 4, wherein the probes inspects different areas of the steel ball.

7. The inspection method for inspecting physical properties of a steel ball by using eddy current as claimed in claim 4, wherein the inspection passage is defined by a push rod and a stationary rod, the push rod is a screw, the steel ball is located in a pitch distance of the push rod, and rotating the push rod makes the steel ball move along the inspection passage.
